(19) United States
(12) Patent Application Publication
(10) Pub. No.: US 2020/0160296 A1
(43) Pub. Date: May 21, 2020

(54) BILL SPLITTING SYSTEM

(71) Applicant: HAREX INFOTECH INC., Seoul (KR)

(72) Inventors: Kyung Yang PARK, Seoul (KR); Moon Ho YANG, Gyeonggi-do (KR); Jung Won LEE, Gyeonggi-do (KR); Seung Eun SONG, Seoul (KR)

(73) Assignee: HAREX INFOTECH INC., Seoul (KR)

(21) Appl. No.: 16/604,853

(22) PCT Filed: Apr. 12, 2018
(86) PCT No.: PCT/KR2018/004293

§ 371 Date: Oct. 11, 2019

(30) Foreign Application Priority Data
Apr. 12, 2017 (KR) 10-2017-0047354

(51) Int. Cl. G06Q 20/10; G06Q 20/32; G06Q 20/20

(52) U.S. Cl. CPC G06Q 20/102; G06Q 20/206; G06Q 20/3223

(57) ABSTRACT

The present invention relates to a bill splitting system. The bill splitting system, according to one aspect of the present invention, comprises a user terminal for requesting bill splitting; and a payment server for receiving payment request information from at least one user terminal according to a bill splitting request for a total payment amount corresponding to inputted order information, and authenticating the payment.

### TECHNICAL FIELD

The present invention relates to a bill splitting system.

### BACKGROUND ART

Along with the development of the related technology, the mobile payment market provides convenient payment means to both users and affiliates.

There has been proposed a method of embedding card information in a user terminal and performing payment using the card information. In this case, when a group of people eat together and each person wants to pay for his or her own meal (with bill splitting), there is an inconvenience in that each user should tell a clerk how much he/she is willing to pay and present his or her credit card to make the payment.

Also, there is another inconvenience in that when payment needs to be made according to a bill splitting request, an affiliate should enter information for each payment and also check whether the payment for the total amount is complete.

### DETAILED DESCRIPTION OF THE INVENTION

### Technical Problem

The present invention is intended to solve the above problems and is directed to providing a bill splitting system capable of conveniently performing bill splitting without a user having to present his or her card directly to an affiliate due to a plurality of user terminals performing bill splitting through individual payment or payer designation on an application.

### Technical Solution

A bill splitting system according to an aspect of the present invention is characterized by including a user terminal configured to request bill splitting and a payment server configured to receive payment request information from at least one user terminal according to a bill splitting request for a total payment amount corresponding to input order information and configured to authenticate the payment.

### Advantageous Effects of the Invention

With the bill splitting system according to the present invention, a plurality of users provided with goods or services may perform payment by entering their own payment amounts, or an amount to be paid is designated by a user terminal leading bill splitting to perform payment, and thus fast and reliable bill splitting is possible.

According to the present invention, users can intuitively check the bill splitting payment status through their terminal, thereby increasing convenience for entering or equally dividing an amount to be paid. From the standpoint of affiliates providing goods or services, there is an effect of solving the problem of a payment waiting time being increased by entering and paying the bill splitting amount separately.

According to the present invention, users can perform bill splitting using a mobile terminal of their choice or can pay an amount he or she is to pay among an amount subject to the bill splitting by cash or plastic card, thereby providing various bill splitting infrastructures.

According to the present invention, by sharing a bill for order information (payment request information) to request payment not only from a person having shared goods or services but also from an acquaintance (a third party, e.g. parents), it is possible to perform bill splitting through third-party payment.

The effects of the present invention are not limited to the aforementioned effects, and other effects not described herein will be clearly understood by those skilled in the art from the above description.

### DESCRIPTION OF THE DRAWINGS

FIG. 1 is a block diagram showing a bill splitting system according to an embodiment of the present invention.

FIGS. 2A to 2C, 3, and 4 are diagrams showing an individual payment process according to a first embodiment of the present invention.

FIGS. 5 to 10 are diagrams showing a payer-specified payment process according to a second embodiment of the present invention.

FIGS. 11 to 14 are diagrams showing an error message pop-up screen according to an embodiment of the present invention.

### BEST MODE

These and other objects, advantages and features of the present invention, and implementation methods thereof will be clarified through following embodiments described with reference to the accompanying drawings.

The present invention may, however, be embodied in different forms and should not be construed as being limited to the embodiments set forth herein. Rather, these embodiments are provided so that this disclosure will fully convey the objects, configurations, and effects of the present invention to those skilled in the art. The scope of the present invention is defined solely by the appended claims.

The terminology used herein is for the purpose of describing embodiments only and is not intended to limit the present invention. As used herein, the singular forms “a,” “an,” and “the” are intended to include the plural forms as well, unless the context clearly indicates otherwise. The terms “comprises” and/or “comprising,” when used in this specification, specify the presence of stated elements, steps, operations, and/or components, but do not preclude the presence or addition of one or more other elements, steps, operations, and/or components.

Hereinafter, in order to help those skilled in the art to understand the present invention, the background of the present invention will be described first, and then the embodiments of the present invention will be described.

A case in which an office worker and his or her co-worker visit a restaurant on a weekday lunchtime, have lunch, and make payment by bill splitting (on table #1, worker A orders kimchi stew for 7,000 won, and worker B orders grilled mackerel for 8,000 won) will be explained by way of example.

In a first case where the office workers want to pay separately for food they ordered, a cashier in the affiliate gets 7,000 won from A and gets 8,000 won from B. In a second case where each of A and B wants to pay 7,500 won, which is obtained by equally dividing the total payment amount, a cashier in the affiliate should proceed with payment to receive 7,500 won from each of the two customers.

In the second case, there is a more inconvenience problem in that the cashier in the affiliate should proceed with payment by directly entering 7,500 won, which is the amount to be paid, to a point-of-sale (POS) terminal because this is not a case where the amount to be paid is automatically calculated when a menu item is entered to the POS terminal.

That is, inconveniently, an affiliate must enter, to a POS terminal, menu items or amounts to be requested for payment for each customer on the basis of order information of each table and then individually make payment by cash or plastic card or by means of a user's mobile terminal (a payment app). This increases a payment waiting time, and thus customer satisfaction drops drastically despite the trouble caused to the clerk.

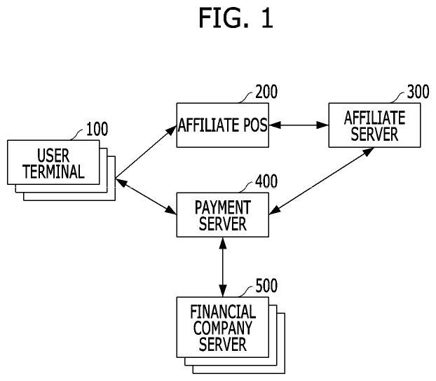

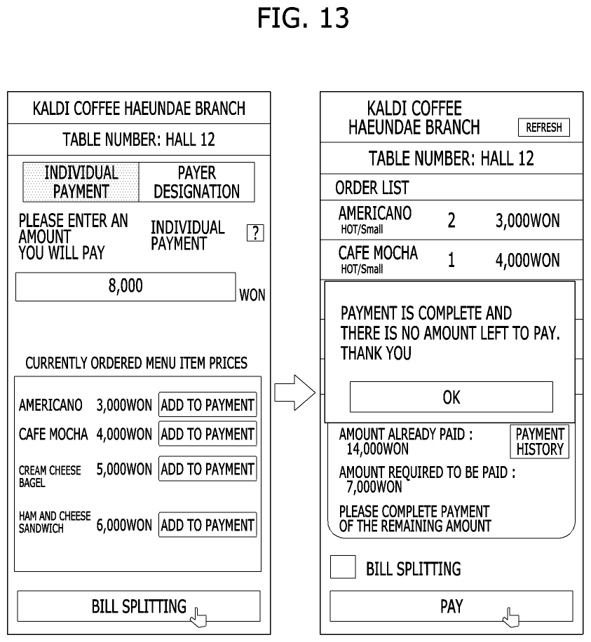

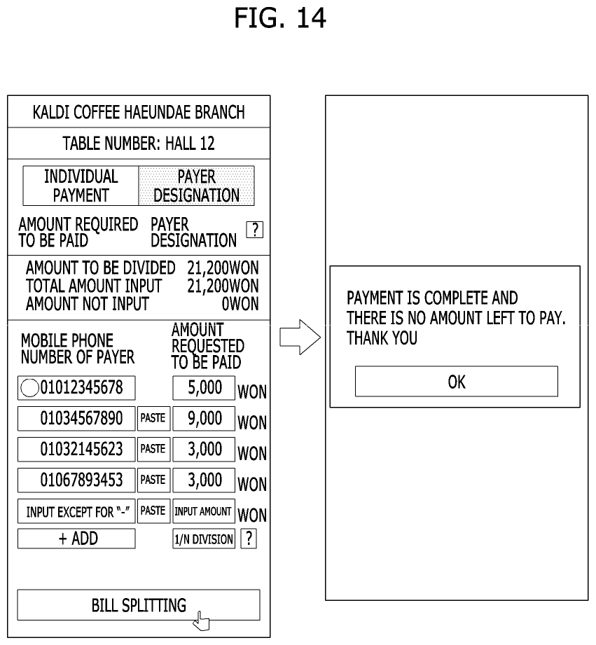

Hereinafter, embodiments of the present invention proposed to solve these problems will be described below with reference to FIGS. 1 to 14.

FIG. 1 is a block diagram showing a bill splitting system according to an embodiment of the present invention.

The bill splitting system according to an embodiment of the present invention includes a user terminal 100 configured to request bill splitting and a payment server 400 configured to receive payment request information from at least two or more user terminals 100 according to a bill splitting request for a total payment amount corresponding to input order information and configured to authenticate the payment.

The user terminal 100 executes a payment app to request bill splitting, and an execution and a payment status of the bill splitting are shared among an affiliate POS 200, an affiliate server 300, and the payment server 400.

When a payment approval request for the bill splitting received from the user terminal 100, the payment server 400 delivers the payment approval request to a financial company server 500, receives an approval result from the financial company server 500, and delivers the received approval result to the user terminal 100, the affiliate server 300, and the affiliate POS 200.

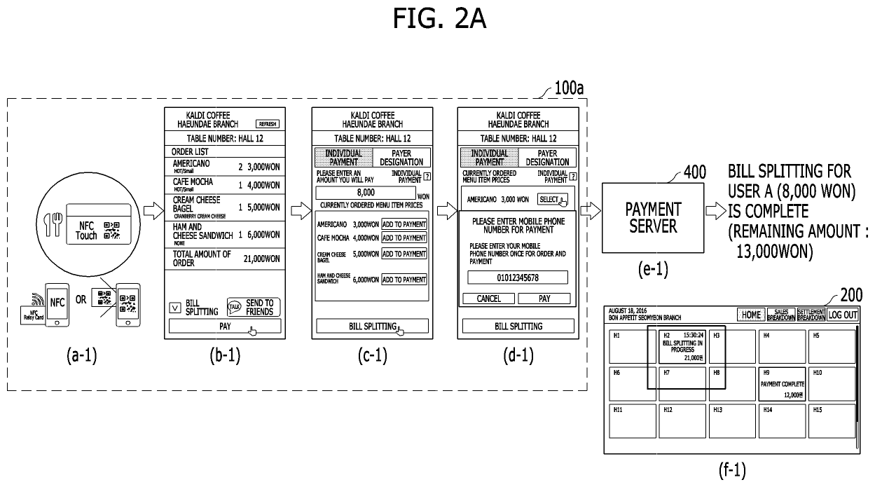

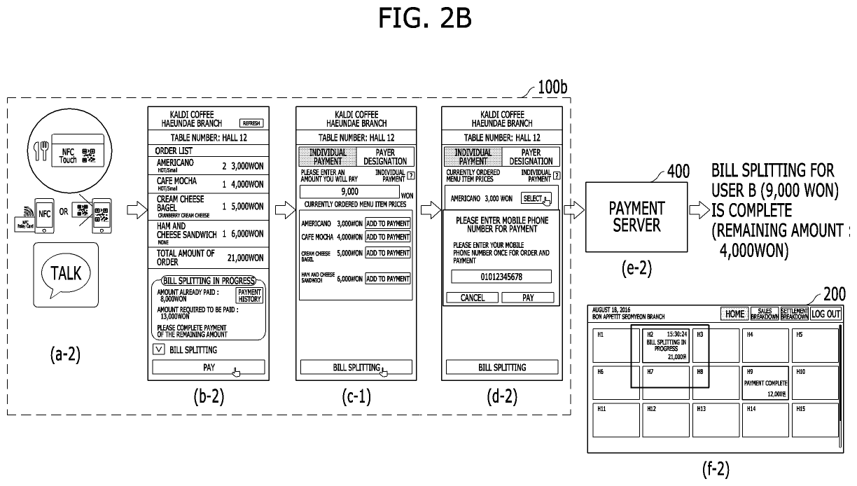

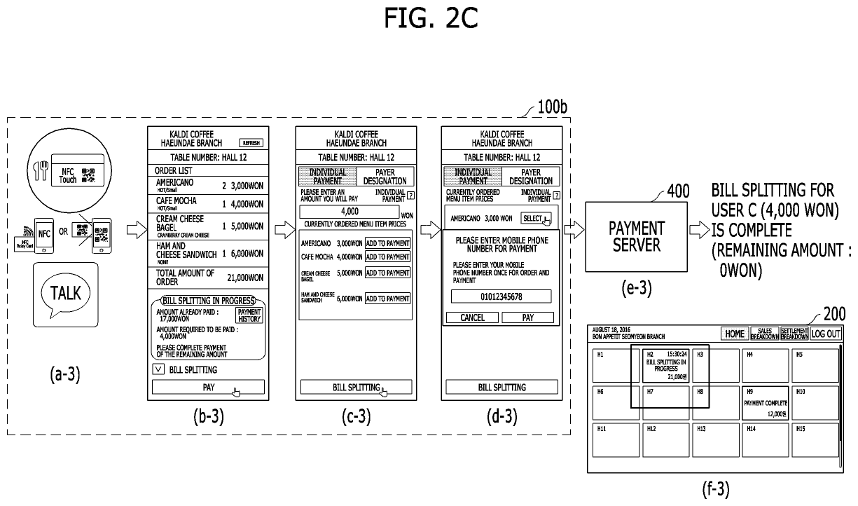

An individual payment process according to a first embodiment of the present invention will be described below with reference to FIGS. 2 to 4.

For better understanding of those skilled in the art, an example in which there are a total of three users A, B, and C will be described below. However, the number of users who execute bill splitting is not limited thereto.

Referring to FIGS. 2A to 2C, first, when the users A, B, and C order their menu items, the number of a table where the users are sitting and order details are entered to the affiliate POS 200.

User A is connected to a mobile bill of a tag (including a unique table number) received through a near field communication (NFC) function or a quick response (QR) code recognition using his or her user terminal 100a.

The QR code recognition or the NFC recognition, which is a recognition means for accessing a tag, i.e., order information for bill splitting, encompasses wireless communication schemes such as a Bluetooth Low Energy (BLE) beacon, Sound, and an RF tag. The scope of the present invention with respect to the recognition means is not limited by the above description.

As shown in FIG. 2A, a mobile bill is summoned by NFC smartphone touch or QR code scan at the table through the user terminal 100a (a-1).

An order list is displayed on the user terminal 100a as shown in (b-1). Screen (c-1) appears when “Bill Splitting” is selected and “Pay” is clicked through the user terminal.

In screen (c-1), user A enters an amount to be paid (8,000 won) through an input screen of his or her terminal 100a and then selects a “Bill Splitting” button. In screen (d-1), user A enters the mobile phone number for the payment through screen (d-1) and then performs bill splitting through a payment app provided from the payment server 400 (e-1).

In this embodiment, a total amount of an order, i.e., the total payment amount, is 21,000 won, and the amount to be paid is updated to the remaining amount (13,000 won) after user A pays 8,000 won. The affiliate POS 200 changes the status from “Pending Payment” to “Bill Splitting in Progress” and then displays the change status through its own screen as shown in (f-1).

The affiliate POS 200 according to an embodiment of the present invention may display the remaining amount according to the bill splitting execution. Alternatively, the affiliate POS 200 may change only the status from “Pending Payment” to “Payment Complete” through “Bill Splitting in Progress” and display the changed status while displaying the total payment amount on the POS screen.

At this time, if some users who share goods or services have difficulty in proceeding with the bill splitting using the mobile terminal, the affiliate POS 200 selects an “Other Payment Processing” button and allows the corresponding bill splitting to be performed through payment processing by cash or plastic card.

For example, three users may receive a service corresponding to a 30,000 won mobile bill and want to pay 10,000 won for each person through bill splitting. In this situation, when two of them complete the bill splitting using their mobile terminals, “Bill splitting is in progress, and the remaining payment mount is 10,000 won” is displayed on the screen of the affiliate POS 200. When the “Other Payment Processing” button is selected, the other person pays the remaining amount by cash or plastic card, and then “Payment Complete” is displayed.

In (d-1) of FIG. 2A, the mobile phone number for the payment only needs to be entered once, and the entered information is stored as web browser cache data.

A browser requests payment through the payment app by using the mobile phone number for the payment. After refreshing, the mobile bill is changed to the status “Bill Splitting in Progress.”

Referring to FIG. 2B, user B summons a mobile bill through NFC smartphone touch or QR code scan at the table by means of a user terminal 100b or summons a mobile bill through a message uniform resource locator (URL) received when the bill splitting is executed using the user terminal 100a (a-2), as shown in FIG. 2B.

An order list and a bill splitting proceeding status are displayed on the user terminal 100b of user B as shown in (b-2).

Screen (c-2) appears when “Bill Splitting” is selected and “Pay” is clicked through the user terminal 100b.

In screen (c-2), user B enters an amount to be paid (9,000 won) through an input screen of his or her terminal 100B and then selects a “Bill Splitting” button. In screen (d-2), user B enters the mobile phone number for the payment through screen (d-2) and then performs bill splitting through a payment app provided from the payment server 400 (e-2).

In this case, the user may directly perform key-in in order to enter the amount to be paid. However, the user may enter the amount to be paid only by checking information about a currently ordered menu item and a price of the menu item and then clicking an “Add Amount to be Paid” button.

The amount to be paid is updated to the remaining amount 4,000 won after user B pays 9,000 won, and the affiliate POS 200 displays “Bill Splitting in progress” as the status.

As described above, the affiliate POS 200 may display the remaining amount according to the bill splitting (e.g., 4,000 won at this stage) and may display “Bill Splitting in progress” as the status while displaying the total payment amount (e.g., 21,000 won in this embodiment).

As described above, in (d-2) of FIG. 2B, the mobile phone number for the payment only needs to be entered once, and the entered information is stored as web browser cache data.

Referring to FIG. 2C, user C summons a mobile bill through NFC smartphone touch or QR code scan at the table by means of a user terminal 100c or summons a mobile bill through a message URL received when the bill splitting is executed using the user terminal 100a (a-3) as shown in FIG. 2C.

An order list and a bill splitting progress status (a total amount of an order, an amount already paid, and an amount required to be paid) are displayed on the user terminal 100c of user C as shown in (b-3).

Screen (c-3) appears when “Bill Splitting” is selected and “Pay” is clicked through the user terminal 100c.

In screen (c-3), user C enters an amount to be paid (4,000 won) through an input screen of his or her terminal 100c and then selects a “Bill Splitting” button. In screen (d-3), user C enters the mobile phone number for the payment through screen (d-3) and then performs bill splitting through a payment app provided from the payment server 400 (e-3).

When the last user, user C's, payment is complete, the payment of the total payment amount of the order of users A, B, and C is complete. The affiliate POS 200 changes the current payment status from “Bill Splitting in Progress” to “Payment Complete” as shown in (f-3).

As described above, payment request information (a bill) including a table ID is shared among the terminals of user A, B, and C who have shared a service in real time, and bill amount information is updated in real time.

In addition, a bill sent through a mobile messenger (e.g., KakaoTalk) or a text message rather than through direct tagging of a table with a QR code or the like includes a unique order number in a URL. This unique order number is automatically discarded when the payment is complete. When the discarded message is read again, the table orders and payment request information of other users are not accessible.

Also, FIGS. 2A to 2C illustrate a process in which users A, B, and C who have shared a service perform bill splitting using their own terminals. However, according to the present invention, it is possible to provide a bill splitting payment service through a third-party payment as well as only by users who have used the service directly.

As described above, the mobile bill is shared through a URL, and such a URL includes a unique order number.

For example, user C, which is one of the users who have shared the service, does not directly make payment using his or her payment means and may request payment by sending transaction information including information on an amount assigned to user C for the bill splitting to a mobile terminal of a third party (his or her parents).

That is, a third-party terminal that has received proxy payment request information from a purchaser terminal (user C) performs payment related to a corresponding transaction history, and payment-completion-related information is delivered to the affiliate POS 200.

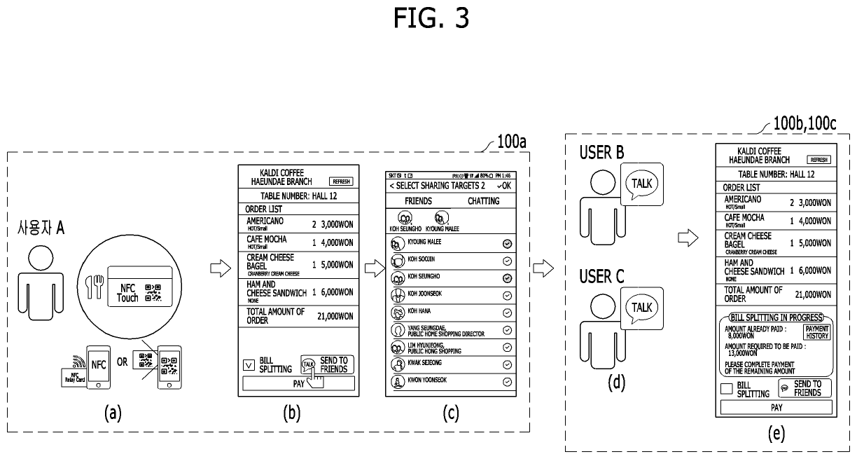

FIG. 3 is a diagram illustrating a bill sensing process according to an embodiment of the present invention.

The user terminal 100a of user A (a) summons a mobile bill through NFC smartphone touch or QR code scan at the table, and (b) a button for sending corresponding order information to a mobile messenger (e.g., KakaoTalk) friend is clicked.

(c) The user terminal 100a of user A selects a friend to share it with through a mobile messenger friend list and (d) transmits a message of a mobile messenger including a URL.

(e) The user terminals 100b and 100c that have received the message click the URL to execute a mobile web browser and display the mobile bill.

As described above, the billing sending process may be performed between people who have shared a service. Also, a mobile bill may be delivered for one of the people who have shared the service to request a proxy payment from a third party.

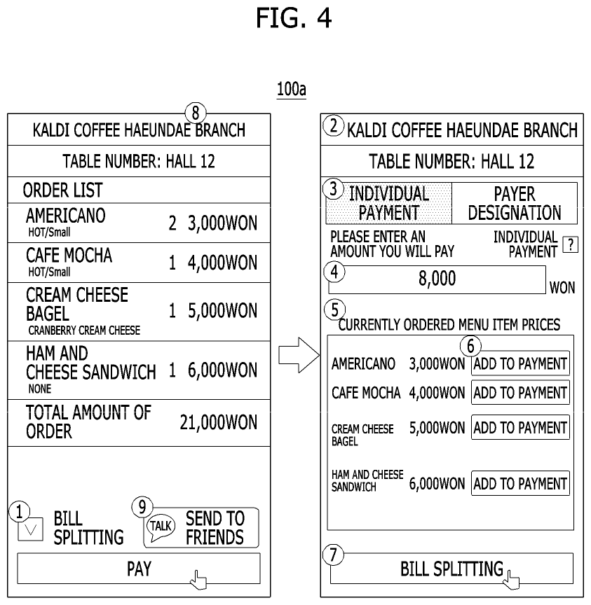

FIG. 4 shows a mobile bill for individual payment according to a first embodiment of the present invention.

\textcircled{1} The processing moves to a bill splitting page when a check box “Bill Splitting” is checked and then when a “Pay” button is selected. A payment mobile phone number input pop-up is summoned when the check box is unchecked and then the “Pay” button is selected.

\textcircled{2} The bill splitting dedicated page is a dedicated page revealed when the “Bill Splitting” and “Pay” buttons are clicked in the mobile bill.

\textcircled{3} is related to tab division and is related to a tab for selecting “Individual Payment” corresponding to the above-described first embodiment and “Payer Designation” corresponding to a second embodiment to be described below.

\textcircled{4} A payment amount input box is an input box to which an amount requested for payment which is desired to be paid is input.

\textcircled{5} The price of a currently ordered menu item exposes an order list menu of the mobile bill, and \textcircled{6} the addition of an amount to be paid is achieved by summing the amounts of menu items selected from an input block for the amount to be paid when a corresponding button is selected.

\textcircled{7} indicates a Bill Splitting button, and when this button is selected, the payment mobile phone number input window pops up.

\textcircled{8} indicates a refresh button, and when this button is selected, a page is refreshed. \textcircled{9} indicates that a URL of a mobile bill is sent to the above-described mobile messenger friend.

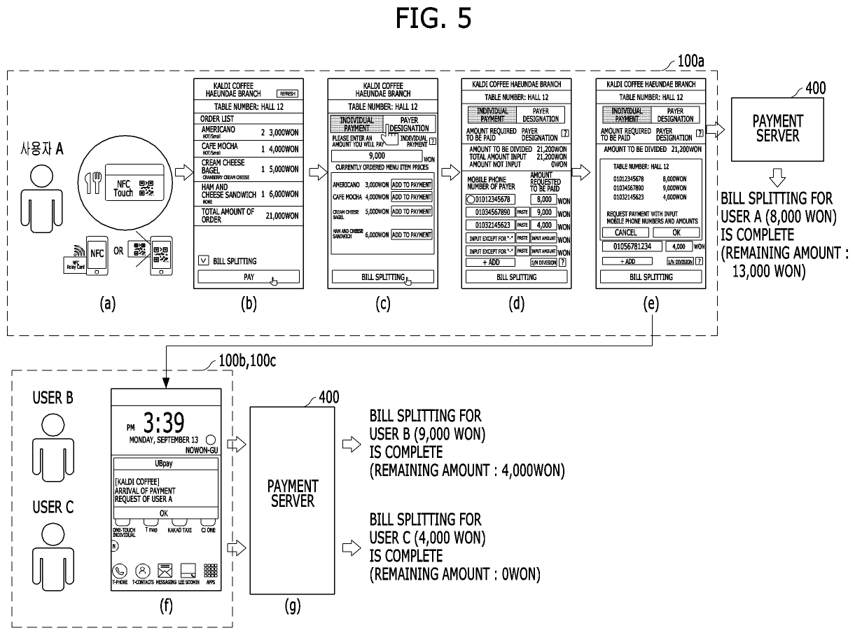

A payer-designated payment process according to a second embodiment of the present invention will be described below with reference to FIGS. 5 to 10.

First, when users A, B, and C order their menu items, order details and a table number where the users are sitting are entered to the affiliate POS.

User A is connected to a mobile bill of a tag (including a unique table number) received through QR code recognition or NFC function using his or her user terminal 100a.

As described above in the first embodiment, the QR code recognition or the NFC recognition is a recognition means for accessing a tag, i.e., order information for bill splitting. The scope of the present invention with respect to the recognition means is not limited by the above description.

As shown in FIG. 5, (a) the user terminal 100a summons a mobile bill through NFC smartphone touch or QR code scan at the table.

An order list is displayed on the user terminal 100a as shown in (b). Screen (c) appears when “Bill Splitting” is selected and “Pay” is clicked through the user terminal 100a.

When a tab “Payer Designation” is selected on screen (c), a payer's mobile phone number and an amount to be paid for each mobile phone number are entered through the input screen of the user terminal 100a as shown in (d).

When the input is complete, a confirmation message for payment request information is displayed on the user terminal 100a as shown in (e), (f) bill splitting for user A is performed through the payment server 400 (8,000 is paid, and the remaining amount is 13,000.)

The user terminal 100b and the user terminal 100c of user B and user C who are designated as payers check a payment request push as shown in (f) and perform payment of amounts requested to be paid which are designated (9,000 won for user B and 4,000 won for user C) through the payment server 400 as shown in (g).

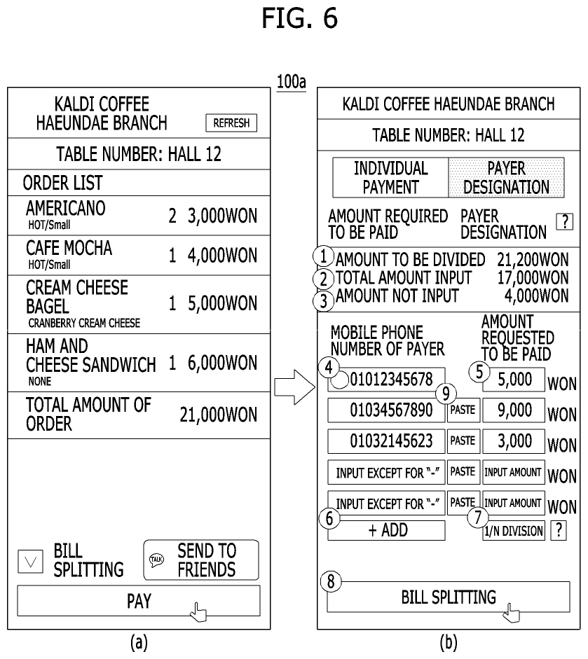

FIG. 6 shows the screen of the user terminal 100a of user A, which is a user terminal leading bill splitting through payer designation.

\textcircled{1} An amount to be divided indicates an amount of an order or an amount required to be paid. \textcircled{2} The sum of amounts entered indicates the sum of amounts requested to be paid of mobile phone numbers of designated payers. \textcircled{3} An amount not entered indicates the amount to be divided minus the entered amounts.

\textcircled{4} A representative payer corresponds to a user terminal leading bill splitting as a flag. \textcircled{5} Amounts requested to be paid are entered through a payment request amount input box, and the sum is displayed as the sum of the entered amounts.

\textcircled{6} An input box for a payer's mobile phone number and an amount requested to be paid is additionally generated when a button for adding a payer's mobile phone number is selected. \textcircled{7} The amount to be divided is equally divided according to the number of payers' mobile phones entered and is automatically input as an amount requested to be paid when a button for 1/N division is selected.

In this case, the 1/N division may be performed through rounding down in units of 100 won, and the remaining amount may be added to the representative payer according to a predetermined scheme.

\textcircled{8} A payment request information confirmation pop-up screen is summoned when the “Bill Splitting” button is selected. \textcircled{9} A paste button corresponds to a function of pasting a number copied from mobile phone contacts, etc.

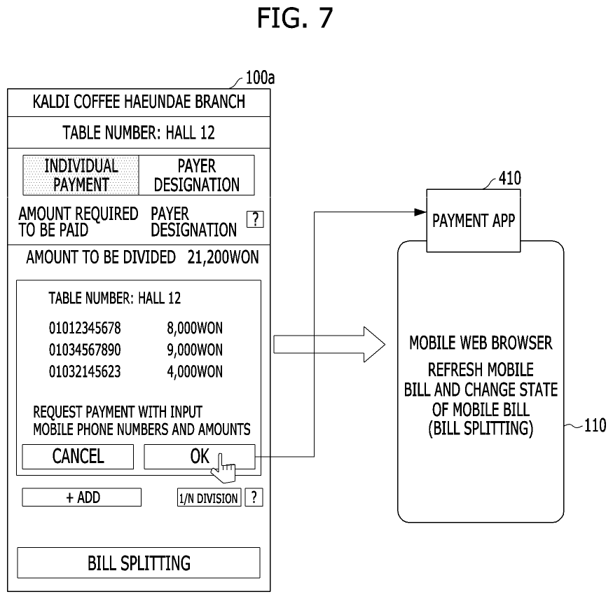

As shown in FIG. 7, when the input of the payer's mobile phone number and the amount requested to be paid are complete and a confirmation message for the payment request information is checked, the bill splitting is performed through the payment app 410, and the mobile web browser 110 refreshes the mobile bill and performs a change in status.

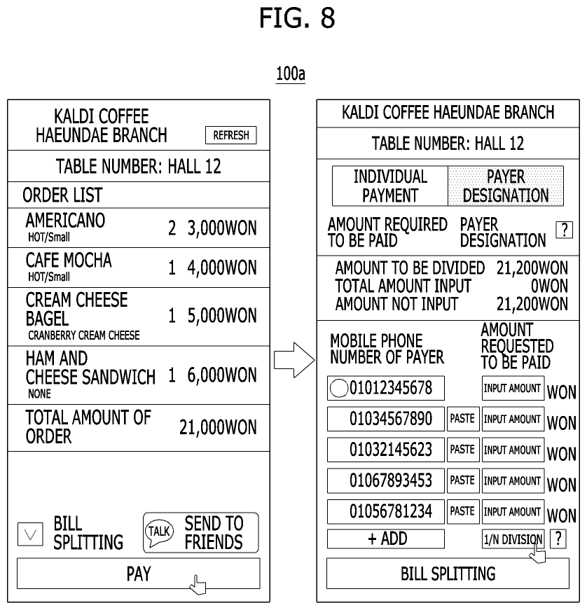

FIGS. 8 to 11 are diagrams showing a 1/N division process according to an embodiment of the present invention.

As shown in FIG. 8, when 1/N division is selected in the user terminal 100a leading the bill splitting, the tab “Payer Designation” is displayed, and an amount obtained by equally dividing the amount to be divided according to the number of payers' mobile phone numbers is automatically input as an amount requested to be paid.

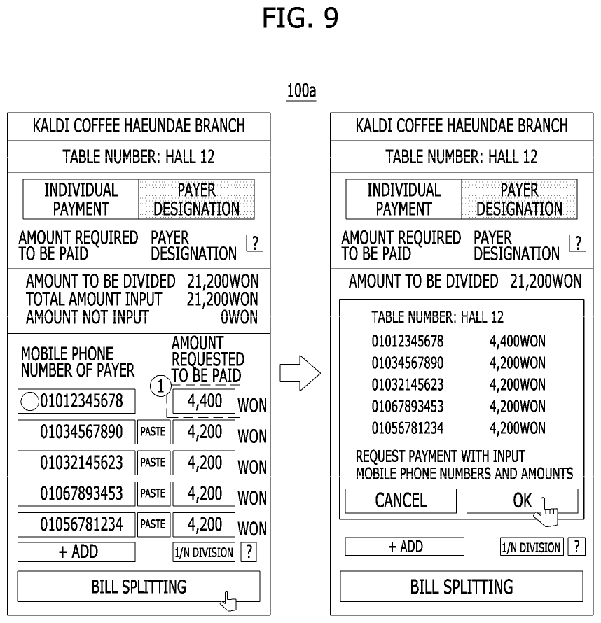

In this case, as shown in FIG. 9, the 1/N division is performed by, for example, rounding down in units of 100 won and adding the remaining amount to the amount requested to be paid of the representative user terminal according to the predetermined equal division scheme, and the sum of the amounts requested to be paid becomes equal to the amount to be divided.

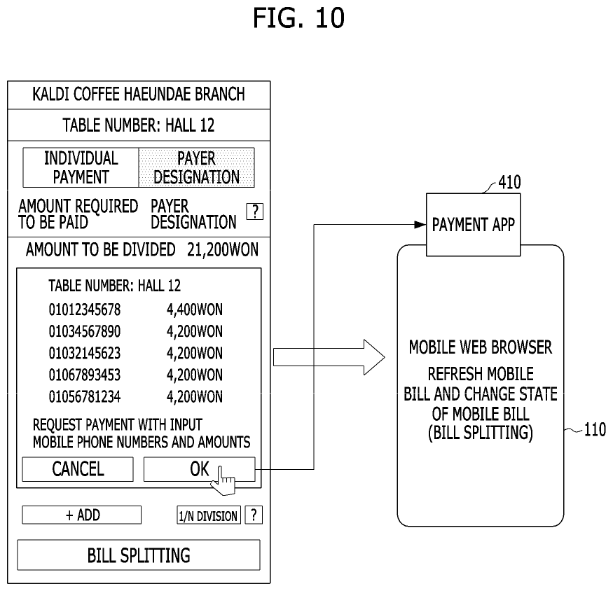

As shown in FIG. 10, when the confirmation message for the payment request information through the 1/N division is confirmed, the bill splitting is performed in the user terminals through the payment app 410, and the mobile web browser 110 refreshes the mobile bill and performs a change in status.

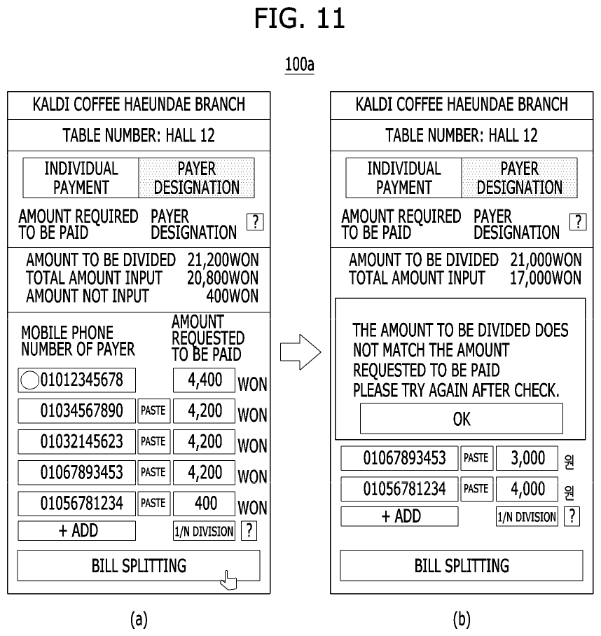

When the sum of the amounts requested to be paid in the user terminal leading the bill splitting does not match the amount to be divided as shown in FIG. 11A, an error message (error information) pops up in the user terminal as shown in FIG. 11B.

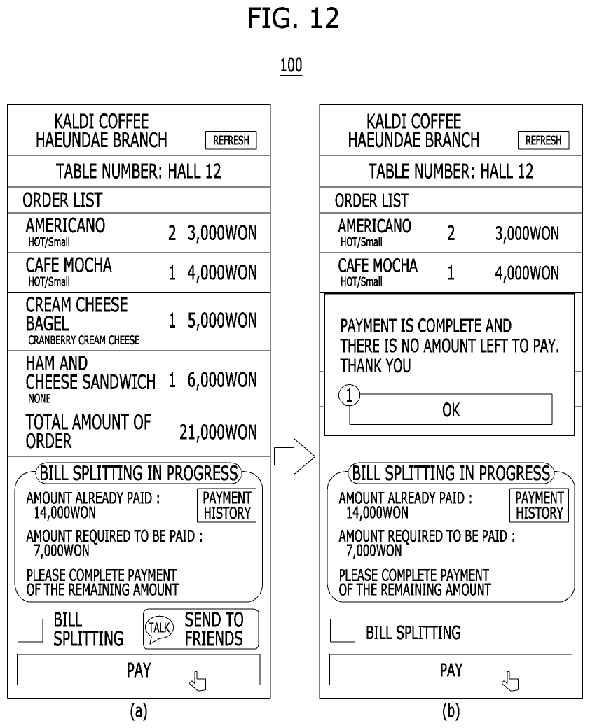

Also, as shown in FIGS. 12 to 14, when the bill splitting of the total payment amount is complete (all other payers pay the remaining amount), the payment server transmits and displays a message indicating that the payment has been completed to the user terminal 100 that requests payment for the corresponding order information.

According to another embodiment of the present invention, when a first user terminal performs payment of the total payment amount by means of its own payment means, the payment server may allow an account transfer request message for the bill splitting to be generated and then transmitted from the first user terminal to designated payer terminals (a second user terminal and a third user terminal).

For example, user A receives a service for which the total payment amount is 21,000 won along with user B and user C, performs payment of the total payment amount using his or her terminal (the first user terminal), and then transmits an account transfer request message for the bill splitting to the terminals of user B and user C.

In this case, account information of user A and amounts requested to be transferred (7,000 won is requested from B and C upon equal division, or 9,000 won is requested from B and 5,000 won is requested from C upon designation by user A) are included in the account transfer request message.

According to still another embodiment of the present invention, the payment server 400 communicates with the affiliate server 300 to transmit discount or accumulation information on the total payment amount to the user terminal 100 (a terminal to perform payment) and performs point discount or accumulation when the payment is authenticated by the user terminal 100.

Accordingly, the user terminal 100 to perform the payment can select a payment means having the highest discount rate from among a plurality of payment means included therein to perform the payment.

According to still another embodiment of the present invention, users A, B, and C may check a mobile bill (total payment amount: 30,000 won), and user A having a payment means having the highest discount rate (Hyundai Card providing a discount of 30%) may receive a discount for the total payment amount, perform the entire payment (the total payment amount after the discount: 21,000 won), and then generate and deliver a message for requesting users B and C to transfer the amounts to user A's account (7,000 won is requested from B and C upon equal division, or 9,000 won is requested from B and 5,000 won is requested from C upon designation by user A).

Also, users A, B, and C may check a mobile bill (a total payment amount: 30,000 won), and user A having a payment means having available points (Hyundai Card providing a point usage of 30%) may receive a discount for the total payment amount by using the points, perform the entire payment (the total payment amount after the discount: 21,000 won), and then generate and deliver a message for requesting users B and C to transfer the amounts to user A's account (in consideration that user A has used his or her points, 10,000 won, which is an equal portion of the total payment amount, that is, 30,000 won before the discount, is requested from B and C, or 7,000 won is requested from B and C upon designation by user A).

Meanwhile, the bill splitting system according to an embodiment of the present invention may be implemented in a computer system or recorded on a recording medium. A computer system may include at least one processor, memory, user input device, data communication bus, user output device, and storage. The above-described elements perform data communication through the data communication bus.

The computer system may further include a network interface coupled to a network. The processor may be a central processing unit (CPU) or a semiconductor device for processing instructions stored in a memory and/or a storage.

The memory and storage may include various types of volatile or non-volatile storage media. For example, the memory may include a read-only memory (ROM) and a random access memory (RAM).

Accordingly, the bill splitting system according to an embodiment of the present invention may be implemented as a computer-executable method. When the bill splitting system according to an embodiment of the present invention is performed by a computer device, computer-readable instructions may implement the bill splitting method according to the present invention.

Meanwhile, the bill splitting method according to the present invention may be embodied as computer-readable codes on a computer-readable recording medium. The computer-readable recording medium includes all types of recording media where data that can be decrypted by a computer system is stored. For example, the computer-readable recording medium may include a ROM, a RAM, a magnetic tape, a magnetic disk, a flash memory, an optical data storage device, and the like. Further, the computer-readable recording media can be stored and carried out as codes that are distributed in a computer system connected to a computer network and are readable in a distributed manner.

The present invention has been described above with respect to embodiments thereof. Those skilled in the art should understand that various changes in form and details may be made therein without departing from the essential characteristics of the present invention. Therefore, the embodiments described herein should be considered from an illustrative aspect rather than from a restrictive aspect. The scope of the present invention should be defined not by the detailed description but by the appended claims, and all differences falling within a scope equivalent to the claims should be construed as being encompassed by the present invention.

1. A bill splitting system comprising:
a user terminal configured to request bill splitting; and
a payment server configured to receive payment request information from at least one user terminal according to a bill splitting request for a total payment amount corresponding to input order information and configured to authenticate payment.

2. The bill splitting system of claim 1, wherein a first user terminal enters information on its own amount to be paid, and the payment server completes a corresponding payment for the first user terminal when the payment is authenticated and updates information on an amount required to be paid by reducing the amount information with respect to the total payment amount.

3. The bill splitting system of claim 2, wherein the payment server transmits the updated amount information required to be paid to a second user terminal that requests the bill splitting and communicates with the second user terminal to pay the requested amount.

4. The bill splitting system of claim 1, wherein the payment server communicates with an affiliate server and an affiliate point of sale (POS) to share bill splitting payment status information according to the reception of the payment request information and the authentication of the payment.

5. The bill splitting system of claim 1, wherein a first user terminal is a terminal leading the bill splitting, and the first user terminal designates a payer to pay the total payment amount and transmits user terminal information and a payment request for an amount to be paid.

6. The bill splitting system of claim 5, wherein a second user terminal receives a payment request message including information on an amount to be paid from the first user terminal and performs the payment using a payment app.

7. The bill splitting system of claim 5, wherein when 1/N division is selected in the first user terminal, the payment server equally divides the total payment amount according to a predetermined scheme and transmits information on the equally divided amount requested to be paid to a terminal of the designated payer.

8. The bill splitting system of claim 1, wherein when the bill splitting of the total payment amount is complete, the payment server transmits a message informing a user terminal requesting payment associated with the corresponding order information that the payment has been already completed.

9. The bill splitting system of claim 1, wherein the user terminal receives ordered menu items included in the order information and price information as a list, adds the price information to the amount to be paid, and requests the bill splitting.

10. The bill splitting system of claim 1, wherein when a first user terminal performs payment on the total payment amount by using its own payment means, the payment server allows an account transfer request message for the bill splitting to be generated and transmitted from the first user terminal to a designated payer terminal.

11. The bill splitting system of claim 1, wherein the payment server communicates with an affiliate server to transmit discount or accumulation information for the total payment amount and performs point discount or accumulation when the payment is authenticated by the user terminal.

12. The bill splitting system of claim 1, further comprising an affiliate terminal configured to display a bill splitting progress status for the total payment amount corresponding to the input order information and perform off-line bill splitting payment by cash or plastic card according to a user request.

13. The bill splitting system of claim 1, wherein the user terminal transmits third-party proxy payment request information for the bill splitting to a third-party terminal, and payment amount information and a mobile bill corresponding to the order information are included in the third-party proxy payment request information.

14. The bill splitting system of claim 1, wherein the order information and the total payment amount is shared between user terminals through a uniform resource locator (URL) in the form of a mobile bill including a unique order number, and the mobile bill is automatically discarded after the payment is complete.
